(19) United States
(12) Patent Application Publication
(10) Pub. No.: US 2024/0314736 A1
(43) Pub. Date: Sep. 19, 2024

(54) COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 18/671,251

(22) Filed: May 22, 2024

Related U.S. Application Data
(63) Continuation of application No. PCT/CN2021/133270, filed on Nov. 25, 2021.

(51) Int. Cl. H04W 68/02; H04W 24/08; H04W 76/28

(52) U.S. Cl. CPC H04W 68/02; H04W 24/08; H04W 76/28

(57) ABSTRACT

A communication method, a terminal device and a network device are provided. The method includes following operations. If a terminal device is configured with extended discontinuous reception (eDRX) and supports packet paging, the terminal device determines, according to an identifier of the terminal device, information of a target paging to be monitored. The identifier of the terminal device is determined according to a preset cycle of the eDRX and/or the maximum number of subgroupings supported by one paging occasion.

### CROSS-REFERENCE TO RELATED APPLICATION

This is a continuation application of International Patent Application No. PCT/CN2021/133270, filed on Nov. 25, 2021, the disclosure of which is hereby incorporated by reference in its entirety.

### BACKGROUND

Paging is used to enable a network to page a terminal device through a paging message in a Radio Resource Control (RRC) idle (RRC_IDLE) state or a RRC inactive (RRC_INACTIVE) state of the terminal device, or inform the terminal device of a system message change or public early warning information such as earthquake and tsunami through a short message.

A reduced capability (RedCap) device may be applied for industrial wireless sensors, video surveillance, wearable devices and other terminal Internet of Things (IoT) devices, with advantages such as low complexity, low cost, low size and lower energy consumption. An Extended Discontinuous Reception (eDRX) mechanism in the idle state or the inactive state has been introduced for a RedCap terminal, to monitor the paging, thereby reducing energy consumption of the terminal device and prolonging a battery life. In order to reduce an unnecessary paging false alarm, a packet paging mechanism may be introduced to further subgroup multiple terminal devices assigned to the same Paging Occasion (PO).

However, when the eDRX and the subgrouping paging are combined, information of the paging to be monitored may not be accurately determined by the terminal device configured with the eDRX and supporting the subgrouping paging if an existing method of defining an identity of the terminal device is adopted.

### SUMMARY

The disclosure relates to the field of communication technologies, and particularly to a communication method, a terminal device and a network device, to solve a problem that the terminal device configured with the eDRX and supporting the subgrouping paging in the related art cannot accurately determine the information of the paging to be monitored.

A first aspect of the disclosure provides a communication method, which includes the following operations.

If a terminal device is configured with eDRX and supports subgrouping paging, the terminal device determines information of a target paging to be monitored based on an identity of the terminal device.

The identity of the terminal device is determined based on a preset cycle of the eDRX and/or a maximum number of subgroupings supported in a paging occasion.

A second aspect of the disclosure provides a terminal device. The terminal device includes a processor and a memory storing computer executable instructions thereon.

The processor executes the computer executable instructions stored in the memory to enable the processor to: if the terminal device is configured with Extended Discontinuous Reception (eDRX) and supports subgrouping paging, determine information of a target paging to be monitored based on an identity of the terminal device. The identity of the terminal device is determined based on a preset cycle of the eDRX and/or a maximum number of subgroupings supported by one paging occasion.

A third aspect of the disclosure provides a network device. The network device includes a processor, a memory and a sender. The memory stores computer executable instructions. The processor executes the computer executable instructions stored in the memory to enable the processor to: configure an index of a paging subgrouping to a terminal device; enable the sender to send an index of the paging subgrouping to the terminal device.

If the terminal device is configured with Extended Discontinuous Reception (eDRX) and supports subgrouping paging, the terminal device monitors subgrouping paging based on the index of the paging subgrouping.

### BRIEF DESCRIPTION OF THE DRAWINGS

In order to more clearly illustrate the technical solution of the present disclosure or the related art, the drawings required in the descriptions of the embodiments or the related art is introduced briefly below. It will be apparent that the drawings in the following description are some embodiments of the disclosure, from which other drawings can be obtained without creative work by those of ordinary skill in the art.

FIG. 1 is a schematic diagram illustrating a mapping relationship between an existing paging frame (PF) and an existing paging occasion (PO) according to an embodiment of the disclosure.

FIG. 2 is a schematic diagram illustrating a scenario of a communication method according to an embodiment of the disclosure.

FIG. 3 is a flowchart illustrating a communication method according to an embodiment of the disclosure.

FIG. 4 is a schematic diagram illustrating a mapping relationship of information of a target paging corresponding to a first identify according to an embodiment of the disclosure.

FIG. 5 is a schematic diagram illustrating a mapping relationship of information of a target paging corresponding to a second identify according to an embodiment of the disclosure.

FIG. 6 is a flowchart illustrating a communication method according to another embodiment of the disclosure.

FIG. 7 is a diagram illustrating signaling interaction of a communication method according to an embodiment of the disclosure.

FIG. 8 is a schematic structural diagram of a communication device according to an embodiment of the disclosure.

FIG. 9 is a schematic structural diagram of a communication device according to an embodiment of the disclosure.

### DETAILED DESCRIPTION

In order to make objects, technical solutions and advantages of the disclosure clearer, the technical a solutions of the embodiments of the disclosure will be clearly and completely described below in combination with the drawings in the embodiments of the disclosure. It is apparent that the described embodiments are not all embodiments but part of the embodiments of the disclosure. All other embodiments obtained by those of ordinary skill in the art based on the embodiments in the disclosure without creative work shall fall within the scope of protection of the disclosure.

The terms “first”, “second” or the like in the specification and claims of the disclosure, as well as above drawings, are used to distinguish similar objects and need not be used to describe a particular order or priority. It should be understood that the data used in this way can be interchanged in appropriate cases, so that the embodiments of the disclosure described herein for example can be implemented in order other than the content illustrated or described herein. In addition, the terms “including” and “having”, as well as any variations thereof, are intended to cover non-exclusive inclusion. For example, a process, method, system, product, or device that includes a series of steps or units, need not be limited to those clearly listed steps or units, but may include other steps or units that are not clearly listed or inherent to these processes, methods, products, or devices.

It should be understood that the terms “system” and “network” used herein are often used interchangeably. Herein, the term “and/or” is only an association relationship that describes associated objects and represents that three relationships may exist. For example, A and/or B may represent three situations: independent existence of A, existence of both A and B and independent existence of B. In addition, the character “/” used herein usually represents that the associated objects before and after the character “/” form an “or” relationship.

The technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

At present, with people's pursuit of speed, latency, high-speed mobility and energy efficiency and the requirements of diversity and complexity of service in future life, International Standards Organization of the 3rd Generation Partnership Project (3GPP) began to develop a 5th Generation Mobile Communication Technology (5G). The main application scenarios of the 5G include Enhanced Mobile Broadband (eMBB), Ultra-reliable and Low Latency Communications (URLLC) and Massive Machine Type Communication (mMTC).

5G New Radio (NR) can also be deployed independently. In a 5G network environment, a new RRC state i.e., RRC_INACTIVE state is defined in order to reduce air interface signaling, quickly recover wireless connections and quickly recover data services. A difference among the RRC_INACTIVE state, a RRC_IDLE state and a RRC active (connected) state is described as follows.

In the RRC_IDLE state, mobility is based on cell selection and reselection of a terminal device, paging is initiated by a core network (CN) device and a paging area is configured by the core network device. There is no Access Stratum (AS) context of the terminal device and no RRC connection on an access network device side.

In the RRC connected state, there is RRC connection exists, and there is the AS context of the terminal device on the access network device and the terminal device. A network side knows that a location of the terminal device is at a cell-specific level. Mobility is controlled by the network side. Unicast data can be transmitted between the terminal device and the access network device.

In the RRC_INACTIVE state, mobility is based on cell selection and reselection of the terminal device, there is connection between the core network device and the NR, there is the AS context of the terminal device on a certain access network device, the paging is triggered by a Radio Access Network (RAN), a RAN-based paging area is managed by the RAN, and the network side knows that the location of terminal device is at an RAN-based paging area level.

A paging mechanism in the 5G NR is described below.

The main function of paging is to enable a network to page the terminal device through a paging message in the RRC_IDLE state or the RRC_INACTIVE state of the terminal device, or notify the terminal device of a system message change or an earthquake and a tsunami/public early warning information through a short message (which is applicable to all RRC states of the terminal device).

Paging includes Physical Downlink Control Channel (PDCCH) scrambled by Paging Radio Network Temporary Identity (P-RNTI) and Physical Downlink Share Channel (PDSCH) scheduled by the PDCCH. The paging message is transmitted in the PDSCH and the short message is 8 bits in the PDCCH.

For the terminal device in the RRC_IDLE state or the RRC_INACTIVE state, because there is no other data communication between the terminal device and the network, the terminal device may discontinuously monitor a paging channel, that is, by adopting a paging Discontinuous Reception (DRX) mechanism, in order to save power for the terminal device. Under the paging DRX mechanism, the terminal device only monitors paging during a paging occasion (PO) in each DRX cycle. TS 38.304 specifies that the PO is composed of multiple PDCCH monitoring occasions on a paging search space, and one PO contains X PDCCH monitoring occasions, and X is equal to the number of Synchronization Signal Blocks (SSBs) broadcasted in a Master Information Block (MIB). In addition, a Paging frame (PF) is also introduced, the PF refers to a radio frame (fixed 10 ms), and the radio frame can contain multiple POs or starting locations of the multiple POs.

A cycle of a paging DRX is jointly determined by a common cycle in system broadcast and a specific cycle configured in high-layer signaling (non-access stratum (NAS) signaling), and the terminal device takes a minimum cycle of the common cycle and the specific cycle as the paging cycle. From a perspective of the network, one paging DRX cycle may have multiple POs, and a location in which the terminal device monitors the POs is related to an identity (i.e., Identity document, ID) of the terminal device (i.e., UE_ID). Specifically, a System Frame Number (SFN) of the PF of the terminal device in the paging DRX is determined by formula (1) (TS 38.304), and index (i_s) of the PO of the terminal device in the paging DRX in the PF is determined by formula (2) (TS 38.304).

$$\\ \begin{matrix}( SFN + PF\_offset ) mod T = ( T div N ) * ( UE\_ID mod N ) & ( 1 )\end{matrix}$$

$$\\ \begin{matrix}i\_s = floor ( UE\_ID / N ) mod Ns & ( 2 )\end{matrix}$$

T denotes a DRX cycle of receiving paging by the terminal device, N denotes the number of PFs in one T, Ns denotes the number of POs in one PF, PF_offset denotes a time domain offset for determining the PF, and UE_ID=5G-S-TMSI mod 1024.

It should be understood that the network broadcasts one default DRX cycle, and if the RRC/high-layer configures a terminal device-specific DRX cycle for the terminal device, the minimum of the DRX cycle broadcasted by the network and the terminal device-specific DRX cycle configured by the RRC/high-layer is taken as the DRX cycle of the terminal device. If the RRC/high-layer does not configure a UE-specific DRX cycle for the terminal device, the DRX cycle broadcasted by the network is taken as the DRX cycle of the terminal device.

It should be noted that after the terminal device calculates the indexes of the PF and the PO and the number of PDCCH monitoring occasions in the PO based on the above formulas, a starting location of a first PDCCH monitoring occasion of the PO is known through relevant configuration parameters, and the starting location is configured through the high-layer signaling. The terminal device blindly detects the paging message based on the determined PO.

A paging false alarm is described below.

It can be seen from the above description that the PO is determined by the terminal device, the PO is determined based on an identity of the terminal device (i.e., UE_ID) and the total number of PFs and POs. When there are many terminal devices in the system and the network cannot allocate the terminal devices to different POs, multiple terminal devices correspond to one PO. If the network is to page a terminal device on this PO, blind detection is performed additionally on other terminal devices which do not have the paging message, including blind detection of the PDCCH and the PDSCH. The wrong paging for these terminal devices that originally do not have the paging message is called a paging false alarm.

In the work project of R17, 3GPP RAN further enhances energy saving of the terminal. One aspect is to design an enhanced paging mechanism to reduce unnecessary paging reception of the terminal device, thereby reducing paging false alarms.

At present, the following mechanisms can be introduced to reduce paging false alarms.
1. Paging Early Indication (PEI) designed based on PDCCH is introduced, that is, the network sends a PEI before the PO, and the terminal device decides whether to monitor the paging normally or skip monitoring for the paging on the PO based on the received PEI.
2. A subgrouping paging mechanism based on terminal device is introduced, that is, multiple terminal devices assigned to the same PO are further grouped, and the network may indicate which terminal device group or groups the paging message is for, thereby avoiding the terminal device in other terminal devices groups from receiving the paging message. Indication information for the paging subgrouping may be carried in the PEI.
3. For paging based on subgrouping of the terminal devices, a group identity (i.e., group ID) in which the terminal device is located may be determined by the core network device. If the core network device does not assign a group ID to the terminal device, the group ID can be determined based on the identity of the terminal device.
4. In order to support a subgrouping mode based on the identity of the terminal device, the access network device broadcasts the number of paging subgroupings based on the identity of the terminal device supported by a cell.
5. In order to support a paging subgrouping mode allocated based on the core network device conveniently, it is assumed that all cells in a registered area support the same number of paging subgroupings allocated based on the core network device, the related technology has not determined how to allocate the number of paging subgroupings based on the core network device.
6. A cell may support both the paging subgrouping based on the identity of terminal devices and the paging subgrouping allocated based on the core network device at the same time, and the grouping ID in the above two subgrouping modes do not overlap. A paging subgrouping indication bit in the PEI corresponds to a paging subgrouping based on the identity of terminal device or the paging subgrouping allocated based on the core network device.

In addition, it should be noted that the maximum number of subgroupings in the subgrouping paging supported by one PO is 8.

A RedCap terminal is described below.

In addition to the application scenarios such as eMBB and URLLC supported by NR, the application examples for example industrial wireless sensors, video surveillance, wearable device and other terminal Internet of Things (IoT) devices put forward, for a 5G terminal, new requirements such as low complexity and cost, size calibration and low energy consumption. Therefore, a RedCap terminal is introduced into R17 NR. At present, the RedCap terminal mainly can be applied to following three scenarios: industrial Wireless Sensors; video surveillance; and wearables.

The industrial Wireless Sensors, compared with URLLC, have relatively low requirements for latency and reliability. The cost and power consumption of industrial wireless sensors are also lower than those of URLLC and eMBB. The main requirements and features of this type of terminal include: communication reliability 99.99%, an end-to-end latency less than 100 ms, a reference data rate less than 2 Mbps and mainly focused on uplink services, static equipment, and a battery life of several years. For safety-related sensors, a latency requirement is lower, ranging from 5 to 10 ms.

The video surveillance is mainly used for video surveillance in a smart city and an industrial factory. The collection and processing of data in the smart city facilitate to monitor and control urban resources more effectively, and provide more effective services for urban residents. Video surveillance is mainly focused on uplink services. Other main requirements further include a reference rate ranging from 2 Mbps to 4 Mbps for a regular resolution video, latency less than 500 ms, the communication reliability ranging from 99% to 99.9%, and a rate requirement ranging from 7.5 Mbps to 25 Mbps for a high-definition video.

The wearables include smart watches, smart bracelets, electronic health devices and some medical monitoring devices. A common feature of wearables is small size. The key indicators required for wearables include: downlink and uplink reference rates ranging from 5 Mbps to 50 Mbps, and 2 Mbps to 5 Mbps, respectively, peak downlink and uplink rates being 150 Mbps and 50 Mbps, respectively. The battery is required to work for several days or even 1 to 2 weeks.

An eDRX mechanism of NR RedCap is described below.

The eDRX mechanism in the idle state or the inactive state is introduced for the RedCap, to save power for the terminal and prolong the battery life.

It should be understood that, eDRX of the terminal device in the RRC_IDLE state is configured by the core network device, and a maximum CN eDRX cycle supported by the terminal device is 10485.76 s. The RAN may configure a RAN eDRX cycle for the terminal device in the RRC_INACTIVE state with reference to the core network device eDRX configuration, and a maximum RAN eDRX cycle supported by the terminal device is 10.24 s. If the eDRX cycle configured by the core network device for the terminal device in the RRC_IDLE state and RRC_INACTIVE state exceeds 10.24 s, the terminal device will monitor the paging on a PO of the terminal device within a Paging Time Window (PTW) in one eDRX cycle. If the eDRX cycle does not exceed 10.24 s for the terminal device in the RRC_IDLE state and RRC_INACTIVE state, the PTW, the PH and the like are not used for the paging monitoring.

An existing method for determining an identity of a terminal device is described below.

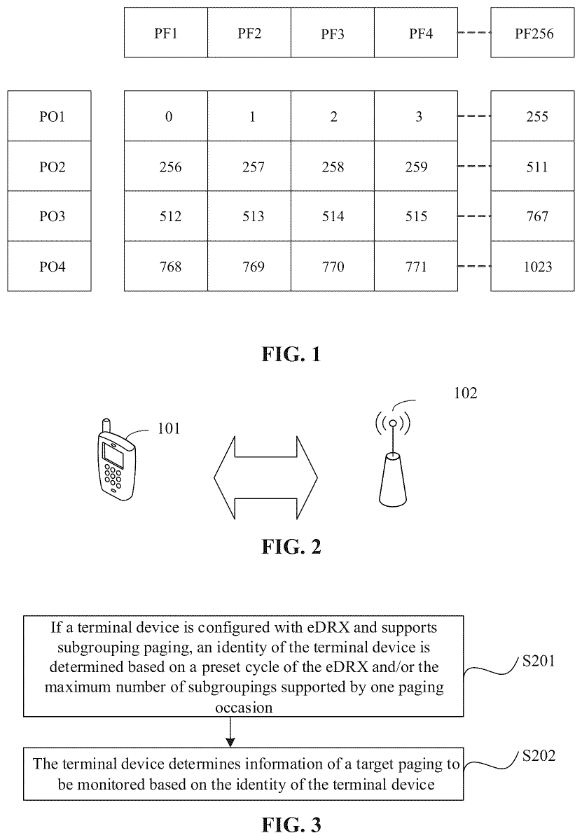

In the related art, the terminal device calculates locations of the PF and the PO corresponding to the terminal device based on the identity of the terminal device. The identity of the terminal device, i.e., UE_ID=5G-S-TMSI mod 1024. A maximum value of N is 256, and a maximum value of Ns is 4. Therefore, the maximum number of POs contained in one DRX cycle T is 256*4=1024. FIG. 1 is a diagram of a mapping relationship between existing PFs and POs according to an embodiment of the disclosure. As illustrated in FIG. 1, different terminal devices may be distributed to different PFs/POs using 10 Least Significant Bits (LSB) of 5G-S Temporary Mobile Subscriber Identity (TMSI) (i.e., 5G-S-TMSI mod 1024).

After introducing the eDRX, due to the maximum value of N being 1024 (corresponding to T=10. 24 s), the maximum number of POs in T is 4096. At this time, in order to be able to distribute different UEs to different PFs and/or POs, the UE_ID may be defined as 5G-S-TMSI mod 4096 for the eDRX.

Also, for paging based on subgrouping, in order to distribute different UEs mapped to the same PO to different paging subgroupings, the UE_ID can be defined as 5G-S-TMSI mod X, herein, X is equal to 1024*the maximum number of subgroupings that can be supported, but the eDRX is not considered.

Therefore, when the eDRX and the subgrouping paging are used in combination, information of the paging to be monitored may not be accurately determined for the terminal device configured with the eDRX and supporting the subgrouping paging if an existing definition method of the identity of the terminal device is adopted. As a result, some subgrouping indexes (i.e., subgrouping IDs) may never be used.

In order to solve the above problems, the embodiments of the disclosure provide a communication method and device. If a terminal device is configured with eDRX and supports subgrouping paging, an identity of the terminal device is determined based on a preset cycle of the eDRX and/or the maximum number of subgroupings supported by a paging occasion, thereby ensuring that information of a target paging is accurately determined based on the identity of the terminal device corresponding to the eDRX and the subgrouping paging.

An example of an application scenario of the disclosure is described below.

FIG. 2 is a diagram illustrating a scenario of a communication method according to an embodiment of the disclosure. FIG. 2 shows communication between a terminal device 101 and a network device 102. The network device 102 may page the terminal device 101 in the RRC_IDLE state or the RRC_INACTIVE state of the terminal device 101. Correspondingly, the terminal device 101 may monitor the paging of the network device 102. When the terminal device 101 is configured with the eDRX and supports the subgrouping paging, the terminal device 101 may determine the identity of the terminal device 101 based on the preset cycle of the eDRX and/or the maximum number of subgroupings supported by a paging occasion, and determine information of the paging of the network device 102 based on the identity of the terminal device 101.

The terminal device 101 includes, but is not limited to, a satellite or a cellular phone; a Personal Communication System (PCS) terminal that combines a cellular radio telephone with data processing, a fax, and a data communication capacity; a Personal Digital Assistant (PDA) that may include a radio telephone, a pager, an Internet/Intranet access, a Web browser, a notebook, a calendar, and/or a Global Positioning System (GPS) receiver; a conventional laptop and/or handheld receiver, or other electronic devices including a radio telephone transceiver. The terminal device may be referred to as an access terminal, User Equipment (UE), a user unit, a user station, a mobile station, a mobile platform, a remote station, a remote terminal, a mobile device, a user terminal, a terminal, a wireless communication device, a user agent or a user device. The access terminal may be a cellular phone, a cordless phone, a Session Initiation Protocol (SIP) phone, a Wireless Local Loop (WLL) station, a PDA, a handheld device with a wireless communication function, a computing device, another processing device connected to a wireless modem, a vehicle-mounted device, a wearable device, a terminal device in the 5G network, a terminal device in the future evolved Public Land Mobile Network (PLMN) and/or the like.

The network device 102 may provide communication coverage for a specific geographic area and may communicate with a terminal device located in the coverage area. Optionally, the network device 102 may be a Base Transceiver Station (BTS) in a Global System for Mobile Communication (GSM) system or in a Code Division Multiple Access (CDMA) system. The network device 102 may also be a NodeB (NB) in a Wideband Code Division Multiple Access (WCDMA) system. The network device 102 may further be Evolutional Node B (eNB or eNode B) in a Long Term Evolution (LTE) system, or a wireless controller in a Cloud Radio Access Network (CRAN). The network device may further be a mobile switching center, a relay station, an access point, a vehicle-mounted device, a wearable device, a hub, a switch, a bridge, a router, a network device in a 5th Generation (5G) network, or a network device in a future evolved PLMN, etc.

The technical solution of the embodiments of the disclosure is described in detail by taking a communication device such as the network device and the terminal device as an example. The following specific embodiments may be combined with each other, and may not be repeated in some embodiments with respect to the same or similar concepts or processes.

FIG. 3 is a flowchart illustrating a communication method according to an embodiment of the disclosure. The executive body of the embodiment of the disclosure is a terminal device, which involves a process of how the terminal device determines information of a target paging to be monitored. As illustrated in FIG. 3, the method includes the following operations.

As operation S201, if the terminal device is configured with eDRX and supports subgrouping paging, an identity of the terminal device is determined based on a preset cycle of the eDRX and/or the maximum number of subgroupings supported by a paging occasion.

In the disclosure, when a terminal device is configured with the eDRX and supports the subgrouping paging, the terminal device does not use the existing method of determining the identity of the terminal device, in order to prevent obtaining inaccurate information of the target paging, and enable some indexes of the paging subgrouping to be unusable.

It should be noted that the terminal device supports the subgrouping paging, which may be understood as that the terminal device has a capability of the subgrouping paging. Further, in some embodiments, the terminal device may have the capability of subgrouping paging based on the identity of the terminal device.

It should be understood that the preset cycle of the eDRX is not limited in the embodiments of the disclosure, and may be set based on an actual situation. For example, the preset cycle of the eDRX may be set to 10.24 s. Correspondingly, the number of PFs in the preset cycle of the eDRX may be 1024. Due to the maximum number of POs in one PF is 4, the maximum number of POs in the preset cycle of the eDRX is 4*1024=4096.

It should be noted that a cycle of the eDRX configured by the terminal device may be equal to the preset cycle of the eDRX or may be less than the preset cycle of the eDRX in the embodiment of the disclosure, which is not limited by the embodiment of the disclosure. For example, the cycle of the eDRX configured by the terminal device may be 5.12 s or 10.24 s.

Correspondingly, the maximum number of subgroupings supported by the paging occasion is not limited in the embodiments of the present disclosure, and in some embodiments, the maximum number of subgroupings supported by the paging occasion may be the maximum number of subgroupings supported based on the identity of the terminal device.

It should be understood that the method for determining the maximum number of subgroupings supported by the paging occasion is not limited in the embodiments of the present disclosure. In some embodiments, the maximum number of subgroupings supported by the paging occasion may be indicated by a network device or determined by predefined information. For example, the maximum number of subgroupings supported by the paging occasion may be defined as 8.

It should be understood that how to determine the identity of the terminal device is not limited in the embodiments of the disclosure, and two different modes may be used based on a determination of whether the network device configures an index of the paging subgrouping for the terminal device.

In a first mode, the terminal device determines the index of the paging subgroupings using the identity of the terminal device. Correspondingly, the identity of the terminal device may be a first identity, the first identity is determined based on the maximum number of paging occasions included in the preset cycle of the eDRX and the maximum number of subgroupings supported by the paging occasion. For example, the first identity (i.e., UE ID1) may be determined using Formula (3).

$$\\ \begin{matrix}UEID 1 = 5 G - S - TMSI mod ( 4096 * Ng\_max ) & ( 3 )\end{matrix}$$

4096 denotes the maximum number of POs in the preset cycle of the eDRX and Ng_max denotes the maximum number of subgroupings supported by the paging occasion.

It should be noted that the preset cycle of the eDRX in formula (3) is 10.24 s, and may be other values in a practical application, and formula (3) does not constitute a restriction.

It should be noted that when the terminal device determines the index of the paging subgrouping by using the identity of the terminal device is not limited in the embodiments of the disclosure, which may include but not be limited to the following two situations. In a first situation, the network does not assign the index of the subgrouping paging to the terminal device, and the terminal device determines the index of the paging subgrouping based on the identity of the terminal device. In another situation, the core network device assigns the index of the subgrouping paging o the terminal device, but the access network device of a current cell does not support the index of the paging subgrouping assigned by the core network device, then the terminal device needs to use the index of the paging subgrouping determined based on the identity of the terminal device in the current cell.

In the second situation, the network device sends the index of the paging subgrouping to the terminal device, and the terminal device monitors paging in the current cell using the index of the paging subgrouping assigned by the network device. Correspondingly, the identity of the terminal device may be a second identity, and the second identity is determined based on the maximum number of paging occasions in the preset cycle of the eDRX. For example, the above-mentioned second identity (i.e., UE ID2) may be determined according to formula (4).

$$\\ \begin{matrix}UEID 1 = 5 G - S - TMSI mod ( 4096 ) & ( 4 )\end{matrix}$$

It should be noted that the network device for configuring the index of the paging subgrouping for the terminal device may be a core network (CN) device.

At operation S202, the terminal device determines information of a target paging to be monitored based on the identity of the terminal device.

In this operation, after the terminal device determines the identity of the terminal device, the information of the target paging to be monitored may be determined based on the identity of the terminal device.

The information of the target paging includes a paging frame and the paging occasion.

It should be understood that how to determine the paging frame and the paging occasion is not limited in the embodiments of the disclosure. For example, a SFN code corresponding to the PF may be determined according to formula (5), a code i_s within the PF may be determined according to formula (6).

$$\\ \begin{matrix}( SFN + PF\_offset ) mod T = ( T div N ) * ( UEID mod N ) & ( 5 )\end{matrix}$$

$$\\ \begin{matrix}i\_s = floor ( UEID / N ) mod Ns & ( 6 )\end{matrix}$$

UE ID denotes the identity of the terminal device, and the UE ID may be the first identity (UE ID1) or the second identity (UE ID2), which is not limited by the embodiment of the disclosure. T denotes a DRX cycle used by the terminal device for monitoring the paging. N denotes the number of PFs in one T. Ns denotes the number of POs in one PF. PF_offset denotes a time domain offset for determining the PF.

In some embodiments, the information of the target paging may include an index of a paging subgrouping in which the terminal device is located. Correspondingly, if the identity of the terminal device configured with the eDRX and supporting the subgrouping paging determines the paging subgrouping in which the terminal device is located, the terminal device may determine the index of the paging subgrouping to which the terminal device belongs using the first identity.

How to determine the index of the paging subgrouping in which the terminal device is located based on the first identity is not limited in the embodiments of the disclosure, and the index of the paging subgrouping may be determined according to for example formula (7).

$$\\ \begin{matrix}subgroupingID = floor ( UEID 1 / ( N * Ns ) ) mod Ng & ( 7 )\end{matrix}$$

Subgrouping ID denotes the index of the paging subgrouping, Ns denotes the number of POs in one PF, Ng denotes the number of paging subgroupings based on the identity of the terminal device, and Ng may be notified to the terminal device by the network device through broadcasting, and the meanings and values of UE ID1 and Ns herein are consistent with those in formulas (5) and (6), and will not be described here.

In other embodiments, the network device may configure the index of the paging subgrouping for the terminal device. Correspondingly, if the terminal device configured with the eDRX and supporting the subgrouping paging uses the index of the paging subgrouping assigned by the network device in the current cell, the terminal device may directly use the index of the paging subgrouping configured by the network device rather than determining the index of the paging subgrouping based on the identity of the terminal device.

In the disclosure, after the terminal device determines the index of the paging subgrouping, the terminal device may monitor subgrouping paging based on the index of the paging subgrouping.

Optionally, in the embodiments of the disclosure, a cell in which the terminal device is located supports the eDRX and the subgrouping paging.

Optionally, in embodiments of the disclosure, the subgrouping paging includes subgrouping paging based on the identity of the terminal device.

A mapping relationship of the information of the target paging is described below.

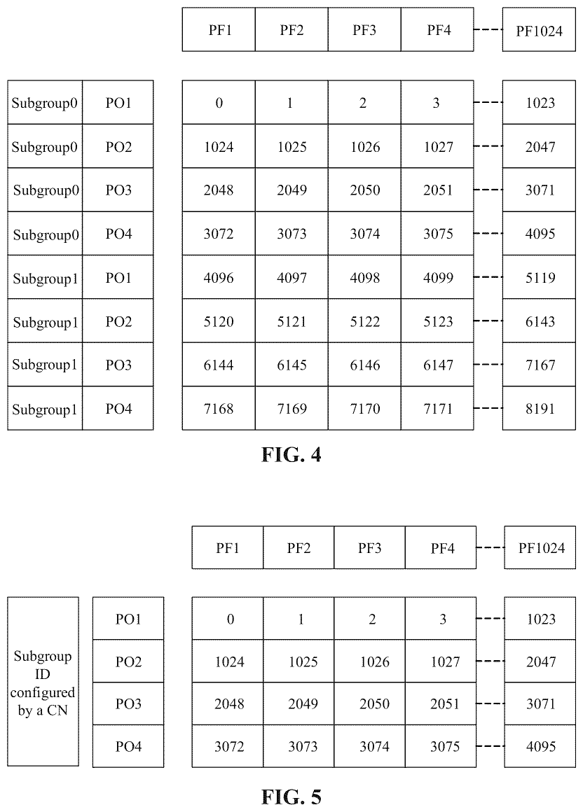

FIG. 4 is a schematic diagram illustrating a mapping relationship of information of a target paging corresponding to a first identify according to an embodiment of the disclosure. FIG. 5 is a schematic diagram illustrating a mapping relationship of information of a target paging corresponding to a second identify according to an embodiment of the disclosure. As illustrated in FIG. 4, N is set to 1024, Ns is set to 4 and Ng is set to 2, and correspondingly, PF includes PF1 to PF1024, PO includes PO1 to PO4, and subgrouping ID includes subgrouping 0 and subgrouping 1. As illustrated in FIG. 5, N is set to 1024 and Ns is set to 4, and correspondingly, PF includes PF1 to PF1024, PO includes PO1 to PO4, and a value of subgrouping ID is configured by the CN device.

In the communication method provided by the embodiments of the disclosure, if the terminal device is configured with the eDRX and supports the subgrouping paging, the terminal device determines the information of the target paging to be monitored based on the identity of the terminal device. The identity of the terminal device is determined based on the preset cycle of the eDRX and/or the maximum number of subgroupings supported by the paging occasion. In this way, the identity of the terminal device can be determined based on the preset cycle of the eDRX and/or the maximum number of subgroupings supported by the paging occasion, so that the terminal device configured with the eDRX and supporting subgrouping paging can accurately determine the information of the target paging based on the eDRX and the identity of the terminal device corresponding to the subgrouping paging.

On the basis of the above embodiments, the two modes for determining the identity of the terminal device are described in detail below based on the determination of whether the network device allocates the subgrouping index to the terminal device.

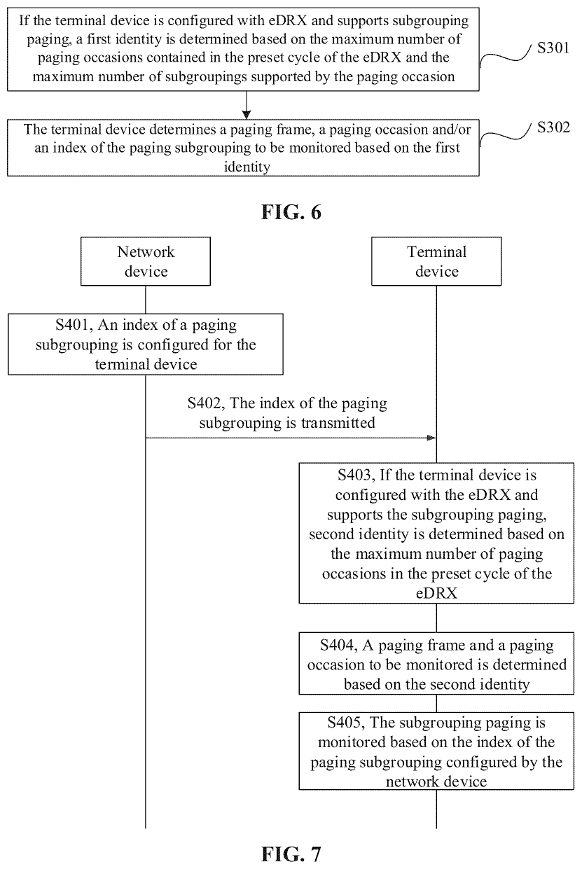

In the first mode, if the network device does not assign the subgrouping index to the terminal device, the identity of the terminal device may be the first identity. FIG. 6 is a flowchart illustrating another communication method according to the embodiment of the disclosure. As illustrated in FIG. 6, the method includes the following operations.

At operation S301, if the terminal device is configured with the eDRX and supports the subgrouping paging, the first identity is determined based on the maximum number of paging occasions in the preset cycle of the eDRX and the maximum number of subgroupings supported by the paging occasion.

At operation S302, the terminal device determines a paging frame, a paging occasion and/or the index of the paging subgrouping to be monitored based on the first identity.

In the embodiment, the terminal device configured with the eDRX and supporting the subgrouping paging calculates the PF and the PO based on the first identity. For the terminal device that determines the paging subgrouping to which terminal device belongs based on the identity of the terminal device, the terminal device determines the index of the paging subgrouping to which the terminal device belongs using the first identity.

It should be noted that the first identifier, the paging frame, the paging occasion and the index of the paging subgrouping may be calculated with reference to as formulas (3)-(7), which are not repeated here.

Optionally, the above formulas for calculating the PF and the PO are applicable to the terminal device configured with the eDRX and having the capability of the subgrouping paging.

Optionally, the above formulas for calculating the PF and the PO are applicable to the terminal device which is configured with the eDRX cycle of 5.12 s and/or 10.24 s and has the subgrouping paging capability.

Optionally, the above formulas for calculating the PF and the PO are applicable to the case in which the cell supports the eDRX and the subgrouping paging.

Optionally, the subgrouping paging supported by the cell is further defined as the subgrouping paging supported by the cell based on the identity of the terminal device.

Optionally, the above formulas for calculating the PF and the PO are applicable to the case that the terminal device is configured with the eDRX and having the capability of the subgrouping paging, and the network device does not assign the index of the paging subgrouping to the terminal device.

Optionally, the above formulas for calculating the PF and the PO are applicable to the case that the terminal device configured with the eDRX and having the capability of the subgrouping paging, and the terminal device determines the paging subgrouping in the current cell using the identity of the terminal device.

Optionally, the terminal device having capability of the subgrouping paging means that the terminal device has capability of the subgrouping paging based on the identity of the terminal device.

In a second mode, the network device assigns a subgrouping index to the terminal device, and the identity of the terminal device may be the second identity. FIG. 7 is a diagram illustrating signaling interaction of a communication method according to an embodiment of the disclosure. As illustrated in FIG. 7, the method includes the following operations.

At operation S401, the network device configures an index of a paging subgrouping to the terminal device.

At operation S402, the network device sends the index of the paging subgrouping to the terminal device.

At operation S403, if the terminal device is configured with an eDRX and supports subgrouping paging, the second identity is determined based on the maximum number of paging occasions in a preset cycle of the eDRX.

At operation S404, the terminal device determines a paging frame and a paging occasion to be monitored based on the second identity.

At operation S405, the terminal device monitors the subgrouping paging based on the index of the paging subgrouping configured by the network device.

In the embodiment, if the network device assigns an index of the paging subgrouping to the terminal device configured with the eDRX and supporting subgrouping paging, and the terminal device uses the index of the paging subgrouping assigned by the network device in the current cell, the terminal device calculates the PF and the PO based on the second identity.

Optionally, the above formulas for calculating the PF and the PO are applicable by the terminal device which is configured with the eDRX and is assigned with the index of the paging subgrouping by the network device.

Optionally, the above formulas for calculating the PF and the PO are applicable to the terminal device that is configured with the eDRX cycle of 5.12 s and/or 10.24 s, and assigned, by the network device, with the index of the paging subgrouping.

Optionally, the above formulas for calculating the PF and the PO are applicable to the case in which the eDRX is configured and the terminal device monitors the subgrouping paging in the current serving cell using the index of the paging subgrouping assigned by the network device.

Optionally, the above formulas for calculating the PF and the PO are applicable to the case in which the configured eDRX cycle is 5.12 s and/or 10.24 s, and the terminal device monitors subgrouping paging in the current serving cell using the index of the paging subgrouping assigned by the network device.

According to the communication method provided by the embodiments of the disclosure, if the terminal device is configured with the eDRX and supports the packet paging, the terminal device determines the information of the target paging to be monitored based on the identity of the terminal device. The identity of the terminal device is determined based on the preset cycle of the eDRX and/or the maximum number of subgroupings supported by the paging occasion. In this way, the identity of the terminal device can be determined based on the preset cycle of the eDRX and/or the maximum number of subgroupings supported by the paging occasion, so that the terminal device configured with the eDRX and supporting subgrouping paging can accurately determine the information of the target paging based on the eDRX and the identity of the terminal device corresponding to the subgrouping paging, thereby avoiding the problem that some indexes of paging subgroupings cannot be used all the time.

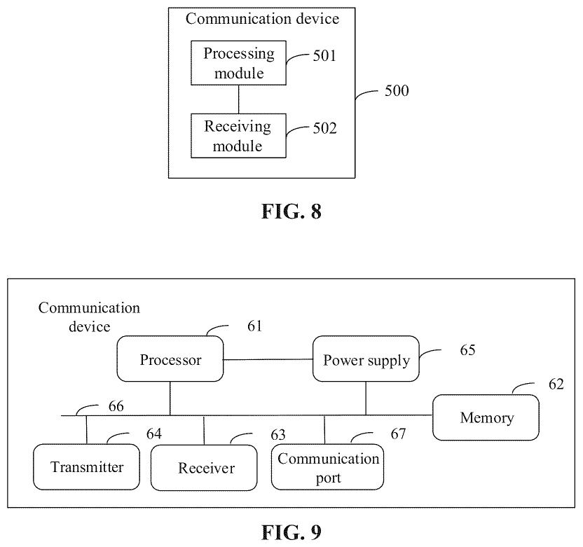

FIG. 8 is a schematic structural diagram of a communication device according to an embodiment of the disclosure. The communication device may be implemented by software, hardware or a combination of the hardware and the software, to implement the communication method in the above embodiments. The communication device may be the above terminal device. As illustrated in FIG. 8, the communication device 500 includes a processing module 501 and a receiving module 502.

The processing module 501 is configured to determine, if the communication device is configured with eDRX and supports subgrouping paging, information of a target paging to be monitored based on an identity of the communication device.

The identity of the communication device is determined based on a preset cycle of the eDRX and/or the maximum number of subgroupings supported by a paging occasion.

In an optional implementation, the information of the target paging includes an index of a paging subgrouping in which the communication device is located.

In an optional implementation, the information of the target paging further includes a paging frame and the paging occasion.

In an optional implementation, the identity of the communication device includes a first identity, and the first identity is determined based on the maximum number of paging occasions in the preset cycle of the eDRX and the maximum number of subgroupings supported by the paging occasion.

In an optional implementation, the maximum number of subgroupings includes a maximum number of subgroupings supported by a cell based on the identity of the communication device.

In an optional implementation, the maximum number of subgroupings is indicated by a network device or determined by predefined information.

In an optional implementation, the identity of the communication device includes a second identity, and the second identity is determined based on the maximum number of paging occasions in the preset cycle of the eDRX.

In an optional implementation, the communication device further includes the receiving module 502.

The receiving module 502 is configured to receive an index of a paging subgrouping configured by a network device.

In an optional implementation, the network device is a core network device.

In an optional embodiment, the processing module is further configured to monitor the target paging based on an index of a paging subgrouping.

In an optional implementation, a cycle of the eDRX configured by the communication device is less than or equal to the preset cycle of the eDRX.

In an optional implementation, a cell in which the communication device is located supports the eDRX and the subgrouping paging.

In an optional implementation, the packet paging includes packet paging based on the identity of the communication device. The communication device provided in the embodiments of the disclosure may perform operations of the communication method in above embodiments, and their implementation principles and technical effects are similar, it will not be repeated here.

FIG. 9 is a schematic structural diagram of a communication device according to an embodiment of the disclosure. As illustrated in FIG. 9, the electronic device may include a processor 61 (e.g. Central Processing Unit, CPU), a memory 62, a receiver 63 and a transmitter 64. The receiver 63 and the transmitter 64 are coupled to the processor 61 which controls a receiving operation of the receiver 63 and controls a sending operation of the transmitter 64. The memory 62 may include a high-speed Random Access Memory (RAM) and may also include non-volatile memory (NVM), for example, at least one disk memory, in which various pieces of information may be stored for implementing various processing functions and implementing method steps of embodiments of the disclosure. Optionally, the electronic device according to the embodiment of the disclosure may further include a power supply 65, a communication bus 66 and a communication port 67. The receiver 63 and the transmitter 64 may be integrated into a transceiver of the electronic device, or each of the receiver 63 and the transmitter 64 may be an independent transceiver antenna on the electronic device. The communication bus 66 is configured to implement the communication connection between the elements. The communication port 67 is configured to implement connection communications between the electronic device and other peripheral devices.

In an embodiment of the disclosure, the memory 62 is configured to store computer executable program code including information. When the processor 61 executes the information, the information causes the processor 61 to execute processing operations on the terminal device side in above method embodiments, causes the transmitter 64 to execute sending operations on the terminal device side in above method embodiments, and causes the receiver 63 to execute receiving operations on the terminal device side in above method embodiments. The implementation principles and technical effects are similar, and will not be repeated here.

An embodiment of the disclosure further provides a communication system, which includes a terminal device and a network device to perform the communication method.

An embodiment of the disclosure further provides a chip, which includes a processor and an interface. The interface is configured to input and output data or instructions processed by the processor. The processor is configured to perform the method provided in above method embodiments. The chip may be applied to the above communication device.

The disclosure further provides a computer-readable storage medium, which can include a U disk, a mobile hard disk, a Read-Only Memory (ROM), a RAM, a magnetic disk, an optical disk and other media capable of storing program codes. Specifically, the computer-readable storage medium stores program information, which is used for the above communication method.

An embodiment of the disclosure further provides a program for performing the communication method provided by the above method embodiments when executed by a processor.

An embodiment of the disclosure further provide a program product, such as a computer-readable storage medium, in which instructions are stored that, when run on a computer, cause the computer to perform the communication method provided by the above method embodiments.

An embodiment of the disclosure also provides an apparatus, which may include at least one processor and an interface circuit. Program instructions are executed in the at least one processor, to cause the communication device to implement the communication method provided by the method embodiments.

The embodiment of the disclosure also provides a communication device for performing the communication method provided by the method embodiments.

The above-described embodiments may be fully or partially implemented by software, hardware, firmware or any combination thereof. When implemented in software, the embodiments may be fully or partially implemented in the form of a computer program product. The computer program product includes one or more computer instructions. When computer program instructions are loaded and executed on a computer, all or part of the processes or functions according to embodiments of the disclosure are generated. The computer may be a general computer, a specialized computer, a computer network, or other programmable device. Computer instructions may be stored in a computer-readable storage medium, or be transmitted from one computer-readable storage medium to another computer-readable storage medium. For example, computer instructions may be transmitted from one website site, computer, server, or data center to another website site, computer, server, or data center through wired (such as, coaxial cable, optical fiber, digital subscriber line (DSL)) or wireless (such as, infrared, wireless, microwave, etc.) manner. The computer-readable storage medium can be any available medium that a computer can store, or a data storage device such as a server or data center that contains one or more available media integrations. The available media can be a magnetic media (such as, floppy disks, hard drives, magnetic tapes), an optical media (such as, DVDs), or a semiconductor media (such as, solid state hard drives (SSDs)) and the like.

Finally, it should be noted that the above embodiments are only used to illustrate the technical solution of the disclosure, rather than a limit for the disclosure. Although the disclosure has been described in detail with reference to the foregoing embodiments, it should be understood by those of ordinary skill in the art that the technical solution described in the foregoing embodiments may be modified, or some or all of the technical features thereof can be equivalently replaced. These modifications or substitutions do not enable the essence of the corresponding technical solution to depart from the scope of the technical solution of the embodiments of the disclosure.

1. A communication method, comprising:
if a terminal device is configured with Extended Discontinuous Reception (eDRX) and supports subgrouping paging, determining, by the terminal device, information of a target paging to be monitored based on an identity of the terminal device,
wherein the identity of the terminal device is determined based on a preset cycle of the eDRX and/or a maximum number of subgroupings supported by one paging occasion.

2. The method of claim 1, wherein the information of the target paging comprises an index of a paging subgrouping in which the terminal device is located.

3. The method of claim 1, wherein the identity of the terminal device comprises a first identity, and the first identity is determined based on a maximum number of paging occasions in the preset cycle of the eDRX and the maximum number of subgroupings supported by one paging occasion.

4. The method of claim 3, wherein the maximum number of subgroupings comprises a maximum number of subgroupings supported by a cell based on the identity of the terminal device.

5. The method of claim 3, wherein the maximum number of subgroupings is indicated by a network device or determined by predefined information.

6. The method of claim 1, wherein a cell in which the terminal device is located supports the eDRX and the subgrouping paging.

7. The method of claim 1, wherein the subgrouping paging comprises subgrouping paging based on the identity of the terminal device.

8. A terminal device, comprising: a processor and a memory, wherein
the memory stores computer executable instructions; and
the processor executes the computer executable instructions stored in the memory to enable the processor to:
if the terminal device is configured with Extended Discontinuous Reception (eDRX) and supports subgrouping paging, determine information of a target paging to be monitored based on an identity of the terminal device,
wherein the identity of the terminal device is determined based on a preset cycle of the eDRX and/or a maximum number of subgroupings supported by one paging occasion.

9. The terminal device of claim 8, wherein the information of the target paging comprises an index of a paging subgrouping in which the terminal device is located.

10. The terminal device of claim 8, wherein the identity of the terminal device comprises a first identity, and the first identity is determined based on a maximum number of paging occasions in the preset cycle of the eDRX and the maximum number of subgroupings supported by one paging occasion.

11. The terminal device of claim 10, wherein the maximum number of subgroupings comprises a maximum number of subgroupings supported by a cell based on the identity of the terminal device.

12. The terminal device of claim 10, wherein the maximum number of subgroupings is indicated by a network device or determined by predefined information.

13. The terminal device of claim 8, wherein a cell in which the terminal device is located supports the eDRX and the subgrouping paging.

14. The terminal device of claim 8, wherein the subgrouping paging comprises subgrouping paging based on the identity of the terminal device.

15. A network device, comprising: a processor, a memory and a sender, wherein
the memory stores computer executable instructions; and
the processor executes the computer executable instructions stored in the memory to enable the processor to:
configure an index of a paging subgrouping to a terminal device;
enable the sender to send the index of the paging subgrouping to the terminal device,
wherein if the terminal device is configured with Extended Discontinuous Reception (eDRX) and supports subgrouping paging, the terminal device monitors subgrouping paging based on the index of the paging subgrouping.

16. The network device of claim 15, wherein a paging frame and a paging occasion to be monitored are determined based on a second identity of the terminal device.

17. The network device of claim 16, wherein the second identity of the terminal device is determined based on a maximum number of paging occasions in a preset cycle of the eDRX.

18. The network device of claim 15, wherein a cell in which the terminal device is located supports the eDRX and the subgrouping paging.

19. The network device of claim 16, wherein the subgrouping paging comprises subgrouping paging based on the second identity of the terminal device.

20. The network device of claim 15, wherein the network device is a core network device.
